(19) United States
(12) Patent Application Publication
(10) Pub. No.: US 2021/0031968 A1
(43) Pub. Date: Feb. 4, 2021

(54) ARTICLE CARRIER AND BLANK THEREFOR

(71) Applicant: WestRock Shared Services, LLC, Atlanta, GA (US)

(72) Inventor: John Valencia, Johns Creek, GA (US)

(21) Appl. No.: 16/945,074

(22) Filed: Jul. 31, 2020

Related U.S. Application Data
(60) Provisional application No. 62/881,554, filed on Aug. 1, 2019.

(51) Int. Cl. B65D 5/20

(52) U.S. Cl. CPC B65D 5/20; B31B 2100/00

(57) ABSTRACT

Aspects of the disclosure relate to a carrier in the form of a tray and to a blank for forming the carrier and to a method of assembling the carrier into a flat collapsible form. The carrier comprises a base wall, opposed side walls hingedly connected to opposed sides of the base wall, and opposed end walls hingedly connected to opposed ends of the base wall. Each of the end walls is coupled to each of the side walls by a corner structure. The corner structure comprises a first corner panel, a second corner panel and a web panel hingedly connected to each of the first and second corner panels. The web panel is disposed between first and second corner panels in face contacting relationship therewith. The web panel comprises a cutaway located distally from the base wall, such that the first corner panel is securable to the second corner panel.

### TECHNICAL FIELD

The present invention relates to an article carrier and to a blank for constructing an article carrier. More specifically, but not exclusively the present invention relates to a folding-type carrier in the form of a tray comprising leak resistant corners. Furthermore, the invention relates to a method of forming a flat collapsed carrier tray.

### BACKGROUND

In the field of packaging it is known to provide trays and other article carriers for holding food items such as but not limited to fast food items. Trays and other carriers are well known in the art and are useful for enabling consumers to transport and access a food item for consumption. For cost and environmental considerations, such trays or carriers need to be formed from as little material as possible and cause as little wastage in the materials from which they are formed as possible. Further considerations are the strength of the tray and its suitability for holding and transporting the item. It is desirable that the contents of the tray are retained within the tray.

Typically, folding-type carriers are either assembled by packaging machinery at a converting plant, which takes flat blanks and automatically carries out the folding and gluing steps to form an erected carrier that can then be shipped to a point-of-sale. The erected carriers are relatively bulky for both transport and storage purposes. Carriers that can be shipped and stored flat, and then easily erected just prior to use, can be advantageous in this regard. It is an object of the present disclosure to provide a such a carrier.

### SUMMARY

A first aspect of the present disclosure provides an article carrier for a foodstuff comprising a base wall, opposed side walls hingedly connected to opposed sides of the base wall and opposed end walls hingedly connected to opposed ends of the base wall. Each of the end walls is coupled to each of the side walls by a corner structure. The corner structure comprises a first corner panel, a second corner panel and a web panel hingedly connected to each of the first and second corner panels. The web panel is disposed between first and second corner panels in face contacting relationship therewith. The web panel comprises a cutaway located distally from the base wall, such that the first corner panel is securable to the second corner panel.

A second aspect of the present disclosure provides a blank for forming an article carrier comprising a base wall, opposed side walls hingedly connected to opposed sides of the base wall and opposed end walls hingedly connected to opposed ends of the base wall. Each of the end walls is coupled to each of the side walls by a corner structure. The corner structure comprises a first corner panel, a second corner panel. A web panel interconnects the first and second corner panels and is hingedly connected to each of the first and second corner panels by first and second hinged connections. The web panel is foldable about the first and second hinged connections so as to be disposed between first and second corner panels in face contacting relationship therewith. The web panel comprises a cutaway located distally from the base wall, such that the first corner panel is securable to the second corner panel.

A third aspect of the present disclosure provides an article carrier for forming a tray for a foodstuff comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels and being disposed between first and second corner panels in face contacting relationship therewith, and wherein the web panel is shorter in height than the first and second corner panels, such that the first corner panel is securable to the second corner panel.

A fourth aspect of the present disclosure provides a blank for forming an article carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels by first and second hinged connections, wherein the web panel is foldable about the first and second hinged connections so as to be disposed between first and second corner panels in face contacting relationship therewith, and wherein the web panel is shorter in height than the first and second corner panels, such that the first corner panel is securable to the second corner panel.

A fifth aspect of the present disclosure provides an article carrier for a foodstuff comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels and being disposed between first and second corner panels in face contacting relationship therewith, and wherein each of the first and second corner panels each comprise a projection providing a securing region such that the first corner panel is securable to the second corner panel.

A sixth aspect of the present disclosure provides a blank for forming an article carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels by first and second hinged connections, wherein the web panel is foldable about the first and second hinged connections so as to be disposed between first and second corner panels in face contacting relationship therewith, and wherein each of the first and second corner panels each comprise a projection providing a securing region such that the first corner panel is securable to the second corner panel.

A seventh aspect of the present disclosure provides an article carrier for a foodstuff comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels and being disposed between first and second corner panels in face contacting relationship therewith, and wherein each of the first and second corner panels each comprise a projection providing a securing region, said securing regions being adjacent to each other.

A eighth aspect of the present disclosure provides a blank for forming an article carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels by first and second hinged connections, wherein the web panel is foldable about the first and second hinged connections so as to be disposed between first and second corner panels in face contacting relationship therewith, and wherein each of the first and second corner panels each comprise a projection providing a securing region, said securing regions being adjacent to each other in an assembled condition.

A ninth aspect of the present disclosure provides an article carrier for a foodstuff comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels and being disposed between first and second corner panels in face contacting relationship therewith, and wherein each of the first and second corner panels each extend radially outward from a corner of the base wall further than the web panel such that the first corner panel is securable to the second corner panel.

A tenth aspect of the present disclosure provides a blank for forming an article carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels by first and second hinged connections, wherein the web panel is foldable about the first and second hinged connections so as to be disposed between first and second corner panels in face contacting relationship therewith, and wherein each of the first and second corner panels each extend radially outward from a corner of the base wall further than the web panel such that the first corner panel is securable to the second corner panel.

Optionally, a frangible line extends continuously across the base wall and opposed side walls such that the article carrier is divisible into two pieces.

Optionally, each of the opposed side walls is hingedly connected to the base wall by a non-linear fold line.

Optionally, the non-linear fold line comprises a pair of linear portions divergently arranged with respect to each other.

Optionally, a frangible line extends continuously across the base wall and opposed side walls such that the article carrier is divisible into two pieces, the frangible line intersects each of the non-linear fold lines at a vertex defined by an intersection between the pair of linear portions.

Optionally, the article carrier is collapsible into a flat condition.

Optionally, the article carrier is erectable from a flat condition in which the end walls are disposed in face to face relationship to the base wall.

Optionally, the side walls and corner structures are automatically erected in response to unfolding the end walls with respect to the base wall.

Optionally, the end walls and corner structures are automatically erected in response to folding the side walls with respect to the base wall.

Optionally, one of the first and second corner panels forms an outer corner panel and extends from a respective one of the opposed side walls to a respective one of the opposed end walls.

Optionally, one of the first and second corner panels forms an outer corner panel and extends from a respective one of the opposed side walls to a respective one of the opposed end walls.

Optionally, one of the first and second corner panels forms an outer corner panel and when viewed from an external viewpoint substantially conceals from view the other one of the first and second corner panels and the web panel.

A eleventh aspect of the present disclosure provides a method of assembling a carrier of the tray type, the carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising an inner corner panel and an outer corner panel and a web panel hingedly connected to each of the first and second corner panels by first and second hinged connections, the method comprising;
folding each of the opposed end walls about hinged connections to the base wall into face contacting relationship with the base wall;
bringing each of the inner corner panels into face contacting relationship with a respective one of the opposed side walls;
applying glue or other adhesive treatment to an inner surface of each outer corner panel;
folding each of the outer corner panels about their hinged connections to one of the opposed side walls;
interposing each web panel between respective ones of the inner and outer corner panels;
bringing each of the outer corner panels into face contacting relationship with a respective one of the inner corner panels; and
securing each of the outer corner panels to said respective one of the inner corner panels.

Optionally, the method further comprises:
erecting the carrier into a tray;
folding each side wall about a hinged connection to the base wall; and
unfolding each end wall about a hinged connection to the base wall.

Optionally, the method further comprises:
erecting the carrier into a tray;
folding each side wall about a hinged connection to the base wall wherein each of the end walls unfolds about a hinged connection to the base wall in response to folding the opposed side walls.

Optionally, the method further comprises:
erecting the carrier into a tray;
unfolding each end wall about a hinged connection to the base wall wherein each of the side walls folds about a hinged connection to the base wall in response to unfolding the opposed end walls.

Optionally, glue or other adhesive treatment is applied to an inner surface of each outer corner panel prior to folding each of the opposed end walls about hinged connections to the base wall into face contacting relationship with the base wall.

A twelfth aspect of the present disclosure discloses use of the method of the preceding paragraphs in a straight-line gluing machine to form a carrier described in the foregoing paragraphs.

Further features and advantages of the present invention will be apparent from the specific embodiments illustrated in the drawings and discussed below.

Within the scope of this application it is envisaged or intended that the various aspects, embodiments, examples, features and alternatives set out in the preceding paragraphs, in the claims and/or in the following description and drawings may be considered or taken independently or in any combination thereof.

Features or elements described in connection with, or relation to, one embodiment are applicable to all embodiments unless there is an incompatibility of features. One or more features or elements from one embodiment may be incorporated into, or combined with, any of the other embodiments disclosed herein, said features or elements extracted from said one embodiment may be included in addition to, or in replacement of one or more features or elements of said other embodiment.

A feature, or combination of features, of an embodiment disclosed herein may be extracted in isolation from other features of that embodiment. Alternatively, a feature, or combination of features, of an embodiment may be omitted from that embodiment.

### BRIEF DESCRIPTION OF THE DRAWINGS

Embodiments of the invention will now be described with reference to the accompanying drawings, in which:

FIG. 1 is a plan view from above of a blank for forming a carrier according to an embodiment of the disclosure;

FIG. 2 is a plan view from above of the blank of FIG. 1 formed into carrier and arranged in a flat collapsed condition;

FIG. 3 is a perspective view from above of a carrier formed from the blank of FIG. 1;

FIG. 4 is a perspective view from above of the carrier of FIG. 3 in a severed condition; and

FIG. 5 is a plan view from above of a blank for forming a carrier according to a further embodiment of the disclosure.

### DETAILED DESCRIPTION OF EMBODIMENTS

Detailed descriptions of specific embodiments of the carriers, blanks and method of construction are disclosed herein. It will be understood that the disclosed embodiments are merely examples of the way in which certain aspects of the invention can be implemented and do not represent an exhaustive list of all of the ways the invention may be embodied. As used herein, the word “exemplary” is used expansively to refer to embodiments that serve as illustrations, specimens, models, or patterns. Indeed, it will be understood that the carriers, blanks and method of construction described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

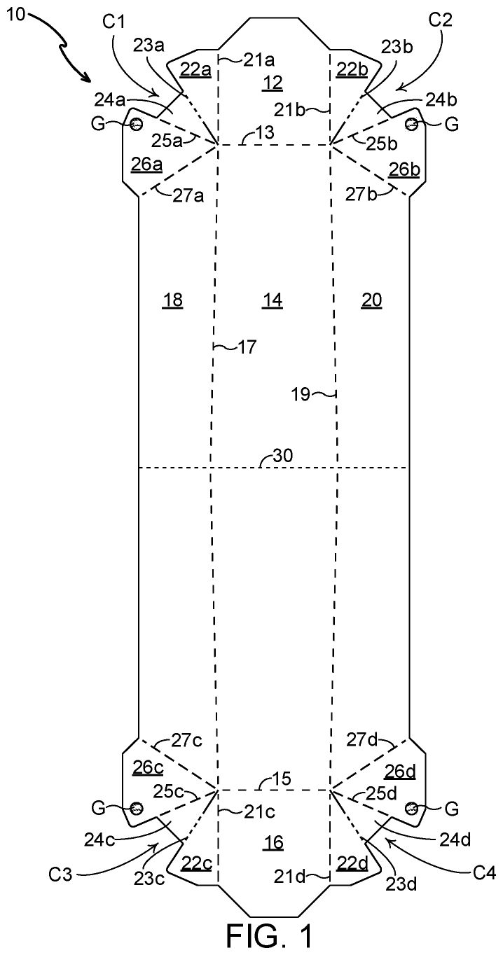

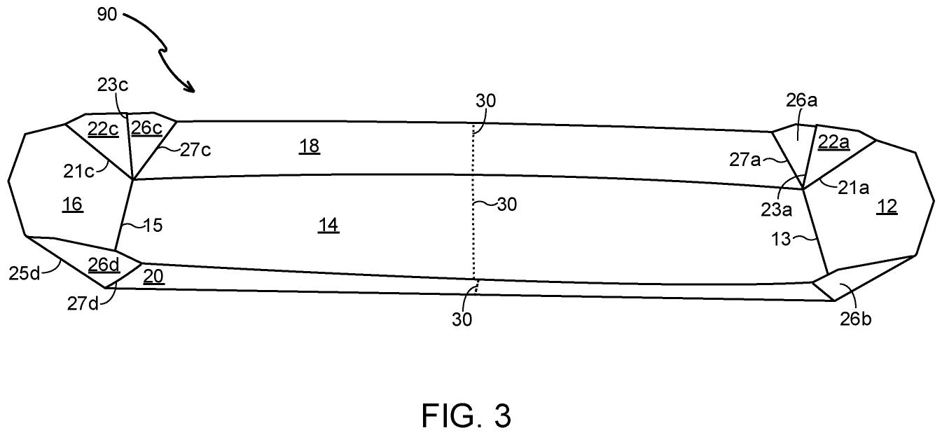

Referring to FIG. 1, there is shown a plan view of a blank 10 capable of forming a tray or carrier 90 (as shown in FIG. 3), for holding a product such as, but not limited to, a food item or combination of food items for example, but not limited to, a hot dog, wrap (soft flatbread rolled around a filling), French fries, potato wedges, nuggets, chicken pieces-wings and drumsticks.

In the embodiments detailed herein, the terms “tray” and “carrier” refer, for the non-limiting purpose of illustrating the various features of the invention, to a container for engaging and carrying a product. It is contemplated that the teachings of the invention can be applied to various products.

The blank 10 is formed from a sheet of suitable substrate. It is to be understood that, as used herein, the term “suitable substrate” includes all manner of foldable sheet material such as paperboard, corrugated board, cardboard, plastic, combinations thereof, and the like. It should be recognised that one or other numbers of blanks may be employed, where suitable, for example, to provide the carrier structure described in more detail below.

The packaging structures or carriers described herein may be formed from a sheet material such as paperboard, which may be made of, or coated with, materials to increase its strength, tear resistance or moisture resistance. Examples of such sheet material are PrintKote® Poly paperboard and CustomKote™ Poly paperboard made by WestRock Company. It should be noted that the resistant materials may be provided by more than one layer, to help improve the moisture or tear resistance of the package. Typically, one surface of the sheet material may have different characteristics to the other surface. For example, the surface of the sheet material that faces outwardly from a finished package may be particularly smooth and may have a coating such as a clay coating or other surface treatment to provide good printability. The surface of the sheet material that faces inwardly may, on the other hand, be provided with a coating, a layer, a treatment or be otherwise prepared to provide properties such as one or more of moisture resistance, tear-resistance, good glue-ability, heat sealability, or other desired functional properties.

The blank 10 may include a paperboard substrate and may also include a moisture resistant layer laminated together. It optionally includes an adhesive layer between the paperboard substrate and the tear resistant layer. The material of the paperboard substrate may be selected from any conventional paperboard, for example, ranging in weight upwardly from about 10 pt., preferably from about 11 pt. to about 14 pt. An example of such a substrate is a 14-point SBS board or CNK board manufactured by WestRock Company. The paperboard substrate may be a bleached or unbleached board. The board may be coated on at least one side, optionally the side opposite the lamination, with a conventional coating selected for compatibility with the printing method and board composition.

The moisture resistant layer may be disposed over the uncoated side of the paperboard substrate and may be formed of polymeric material and secured to the substrate. The moisture resistant layer imparts toughness to the laminate structure. The moisture resistant layer may be a layer of linear low-density polyethylene (LLDPE). In embodiments where linear low-density polyethylene (LLDPE) or mPE is used, it is not necessary to incorporate an adhesive layer. Other suitable materials having a high level of tear or moisture resistance may also be used.

The adhesive layer may be formed of polyolefin material such as a low-density polyethylene (LDPE). The adhesive layer may be placed between the substrate and the tear/moisture resistant layer to secure the tear/moisture resistant layer to the substrate.

Suitable tear/moisture resistant materials may include, but not be limited to, tear resistant laminated sheet material, e.g., NATRALOCK® paperboard made by WestRock Company, which may include a layer of an n-axially oriented film, e.g. MYLAR®, which is a bi-axially oriented polyester, oriented nylon, cross-laminated polyolefin or high density polyolefin. The orientation and cross-laminated structure of these materials contribute to the tear resistant characteristic. Also, tear resistance may be attributed to the chemical nature of the tear resistant material such as extruded metallocene-catalyzed polyethylene (mPE).

Referring to FIG. 1, the blank 10 comprises a base panel 14, opposed end panels 12, 16 and opposed side panels 18, 20. A first end panel 12 is hingedly connected to a first end of the base panel 14 by a hinged connection in the form of a fold line 13. A second end panel 14 is hingedly connected to a second end of the base panel 14 by a hinged connection in the form of a fold line 15. A first side panel 18 is hingedly connected to a first side of the base panel 14 by a hinged connection in the form of a fold line 17. A second side panel 20 is hingedly connected to a second side of the base panel 14 by a hinged connection in the form of a fold line 19. Fold lines 17 and 19 are not parallel to one another.

The blank 10 comprises a corner structure at each corner of the base panel 14. The corner structures couple one of the opposed end panels 12, 16 to one of the opposed side panels 18, 20.

A first corner structure couples the first end panel 12 to the first side panel 18. The first corner structure comprises a first inner corner panel 22a hingedly connected to a first side of the first end panel 12 by a hinged connection in the form of a first fold line 21a. A first outer corner panel 26a is hingedly connected to a first end of the first side panel 18 by a hinged connection in the form of a fourth fold line 27a. A first web panel 24a couples the first inner corner panel 22a to the first outer corner panel 26a. The first web panel 24a is hingedly connected to the first inner corner panel 22a by a hinged connection in the form of a second fold line 23a. The first web panel 24a is hingedly connected to the first outer corner panel 26a by a hinged connection in the form of a third fold line 25a. In this way the first web panel 24a interconnects the first outer corner panel 26a and first outer corner panel 26a.

The first web panel 24a is not co-extensive with its neighbouring, adjacent and adjoining first inner and first outer corner panels 22a, 26a. The first corner structure may be considered as comprising a cutaway or recess C1 which results in the first web panel 24a being shorter in dimension than the first inner corner panel 22a and the first outer corner panel 26a.

It will be appreciated that the first inner corner panel 22a and the first outer corner panel 26a may be considered as extended with respect to the first web panel 24a and longer in dimension than the first web panel 24a. In other words the first inner corner panel 22a and the first outer corner panel 26a project outwardly from the corner of the base panel 14 further than the first web panel 24a. The first inner corner panel 22a and the first outer corner panel 26a may each comprise a securing region defined by projections of the first inner and first outer corner panels 22a, 26a that extend beyond the first web panel 248.

The first inner corner panel 22a and the first outer corner panel 26a each extend radially outward from a common end point; a vertex defined where the fold line 13 and fold line 17 meet. The first inner and first outer corner panels 22a, 26a extend further than the first web panel 24a.

The first fold line 21a and the second fold line 23a define a first angle θ1 therebetween. The second fold line 23a and the third fold line 25a define a second angle θ2 therebetween. The third fold line 25a and the fourth fold line 22a define a third angle θ3 therebetween. The fourth fold line 27a and the fold line 17, hinging the first side panel 18 to the base panel 14 define a fourth angle θ4 therebetween. The sum of the first, second, third and fourth angles θ1, θ2, θ3, θ4 is 180° (degrees).

In this way when the first corner structure is in a folded condition, in which the first web panel 24a is disposed between the first inner corner panel 22a and the first outer corner panel 26a it is possible to secure an outer surface of the first inner corner panel 22a to an inner surface of the first outer corner panel 26a. Beneficially, this may assist in a part formed carrier tray 90 being foldable into a flat collapsed form and/or may assist in the automatic erection of the first corner structure of the carrier tray 90.

A second corner structure couples the first end panel 12 to the second side panel 20. The second corner structure comprises a second inner corner panel 22b hingedly connected to a second side of the first end panel 12 by a hinged connection in the form of a fold line 21b. A second outer corner panel 26b is hingedly connected to a first end of the second side panel 20 by a hinged connection in the form of a fold line 27b. A second web panel 24b couples the second inner corner panel 22b to the second outer corner panel 26b. The second web panel 24b is hingedly connected to the second inner corner panel 22a by a hinged connection in the form of a fold line 23b. The second web panel 24b is hingedly connected to the second outer corner panel 26b by a hinged connection in the form of a fold line 25b. In this way the second web panel 24b interconnects the second outer corner panel 26b and second outer corner panel 26b.

The second web panel 24b is not co-extensive with its neighbouring, adjacent and adjoining second inner and second outer corner panels 22b, 26b. The second corner structure may be considered as comprising a cutaway or recess C2 such that the second web panel 24b is shorter in dimension than the second inner corner panel 22b and the second outer corner panel 26b.

It will be appreciated that the second inner corner panel 22b and the second outer corner panel 26b may be considered as extended with respect to the second web panel 24b and longer in dimension than the second web panel 24b.

In this way when the second corner structure is in a folded condition, in which the second web panel 24b is disposed between the second inner corner panel 22b and the second outer corner panel 26b it is again possible to secure an outer surface of the second inner corner panel 22b to an inner surface of the second outer corner panel 26b.

The second inner corner panel 22b and the second outer corner panel 26b each extend radially outward, from a vertex defined by of the intersection of fold line 13 and fold line 19, further than the second web panel 24b.

A third corner structure couples the second end panel 16 to the first side panel 18. The third corner structure is similar in composition to the first and second corner structures and comprises a third inner corner panel 22c hingedly connected to a first side of the second end panel 16 by a hinged connection in the form of a fold line 21c. A third outer corner panel 26c is hingedly connected to a second end of the first side panel 18 by a hinged connection in the form of a fold line 27c. A third web panel 24c couples the third inner corner panel 22c to the third outer corner panel 26c. The third web panel 24c is hingedly connected to the third inner corner panel 22c by a hinged connection in the form of a fold line 23c. The third web panel 24c is hingedly connected to the third outer corner panel 26c by a hinged connection in the form of a fold line 25c. In this way the third web panel 24c interconnects the third outer corner panel 26c and third outer corner panel 26c.

The third web panel 24c is not co-extensive with its neighbouring, adjacent and adjoining third inner and third outer corner panels 22c, 26c. The third corner structure may be considered as comprising a cutaway or recess C3 such that the third web panel 24c is shorter in dimension than both the third inner corner panel 22c and the third outer corner panel 26c.

It will be appreciated that the third inner corner panel 22c and the third outer corner panel 26c may be considered as extended with respect to the third web panel 24c and longer in dimension than the third web panel 24c.

In this way when the third corner structure is in a folded condition, in which the third web panel 24c is disposed between the third inner corner panel 22c and the third outer corner panel 26c it is possible to secure an outer surface of the third inner corner panel 22c directly to an inner surface of the third outer corner panel 26c.

The third inner corner panel 22c and the third outer corner panel 26c each extend radially outward, from a vertex defined by the intersection of the fold line 15 and fold line 17, further than the third web panel 24c.

A fourth corner structure couples the second end panel 16 to the second side panel 20. The fourth corner structure is similar in composition to the first, second and third corner structures and comprises a fourth inner corner panel 22d, hingedly connected to a second side of the second end panel 16 by a hinged connection in the form of a fold line 21d. A fourth outer corner panel 26d is hingedly connected to a second end of the second side panel 20 by a hinged connection in the form of a fold line 27d. A fourth web panel 24d couples the fourth inner corner panel 22d to the fourth outer corner panel 26d. The fourth web panel 24d is hingedly connected to the fourth inner corner panel 22d by a hinged connection in the form of a fold line 23d. The fourth web panel 24d is hingedly connected to the fourth outer corner panel 26d by a hinged connection in the form of a fold line 25d. In this way the fourth web panel 24d interconnects the fourth outer corner panel 26d and fourth outer corner panel 26d.

The fourth corner structure may be considered as comprising a cutaway or recess C4 such that the fourth web panel 24d is shorter in dimension than the fourth inner corner panel 22d and the fourth outer corner panel 26d. The fourth web panel 24d is not coextensive with its neighbouring, adjacent and adjoining fourth inner and fourth outer corner panels 22d, 26d.

It will be appreciated that the fourth inner corner panel 22d and the fourth outer corner panel 26d may be considered as extended with respect to the fourth web panel 24d, and longer in dimension than the fourth web panel 24d.

In this way when the fourth corner structure is in a folded condition, in which the fourth web panel 24d is disposed between the fourth inner corner panel 22d and the fourth outer corner panel 26d it is possible to secure an outer surface of the fourth inner corner panel 22d to an inner surface of the fourth outer corner panel 26d.

The fourth inner corner panel 22d and the fourth outer corner panel 26d each extend radially outward, from a vertex defined by intersection of the fold line 15 and fold line 19, further than the fourth web panel 24d.

In alternative embodiments the cutaways C1, C2, C3, C4 may take the form of an aperture, the aperture being disposed at a distal end of the web panels 24a, 24b, 24c, 24d, The distal end being opposite a proximal end located proximate a corner of the base panel 14. The corners of the base panel are defined by the intersections or vertices between the fold lines 13 and 17; 13 and 19; 15 and 17; and 15 and 19.

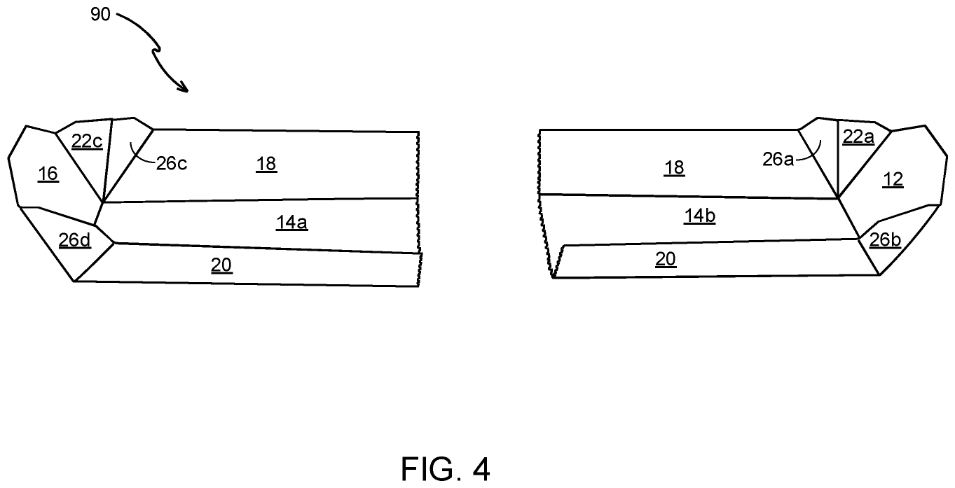

Optionally, the blank 10 comprises a severable or frangible line 30 extending transversely across the base panel 14 and continuing across each of the first and second side panels 18, 20. The frangible line 30 facilitates separation of the carrier 90 into two pieces (also referred to herein as “sections”). The frangible line 30 may be arranged so as to bisect the base panel 14, into two base panel sections 14a, 14b, such that each of the two pieces of the separated tray 90 are substantially equal in length (see FIG. 4).

The fold line 17 between the first side panel 18 and the base panel 14 may be non-linear. In the illustrated embodiment the fold line 17 comprises a first portion extending from the fold line 13 to the frangible line 30 and a second portion extending from the fold line 15 to the frangible line 30.

The first portion is divergently arranged with respect to the second portion. The first and second portions are arranged such that the base panel 14 is wider in dimension at the frangible line 30 or middle, than it is at its opposed ends (defined by the fold lines 13, 15). As can be seen in FIG. 1 the obliquely angled fold lines 17, 19 are non-parallel with one another. The base panel 14 has a non-rectangular shape. The base panel 14 has a six-sided, hexagonal shape due to the non-straight, non-linear, non paralleled, obliquely angled fold lines 17 and 19.

Turning to the construction of the tray-carrier 90 as illustrated in FIG. 3, the tray-carrier 90 can be formed by a series of sequential folding operations in a straight-line machine so that the carrier 90 is not required to be rotated or inverted to complete its construction. The folding process is not limited to that described below and may be altered according to particular manufacturing requirements.

Glue or other adhesive treatment G (see FIG. 1) is applied to a small area of the inner surface of each of the first and second outer corner panels 26a, 26b.

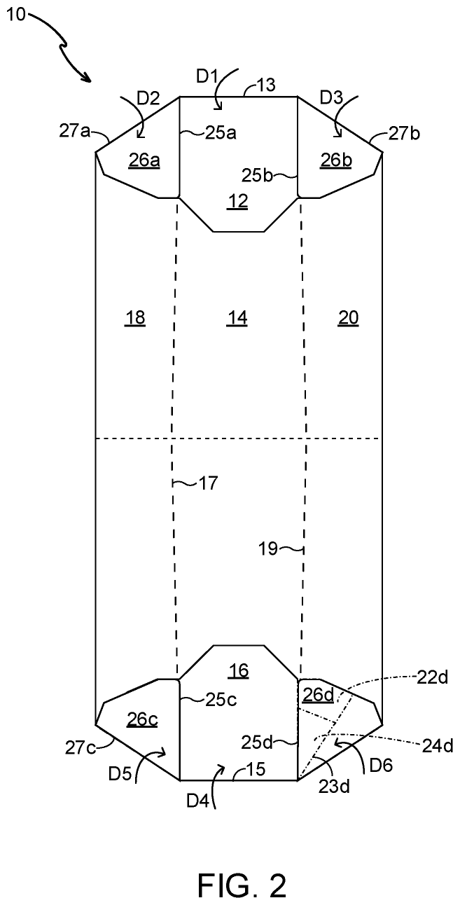

The first end panel 12 is folded, with respect to the base panel 14 about fold line 13, as indicated by direction arrow D1 shown in FIG. 2.

In this way the first end panel 12 is brought into face to face relationship with the base panel 14.

The first inner corner panel 22a is brought into face to face relationship with the first side panel 18. The second inner corner panel 22b is brought into face to face relationship with the second side panel 20.

In alternative embodiments glue or other adhesive treatment may applied to corresponding regions of the outer surface of each of the first and second inner corner panels 22a, 22b. The glue or other adhesive treatment may be applied after folding the first and second inner corner panels 22a, 22b into face to face relationship with the respective one of the first and second side panels 18, 20.

The first web panel 24a is folded with respect to the first inner corner panel 22a and with respect to the first outer corner panel 26a. This folding may be automatic in response to folding the first end panel 12 with respect to the base panel 14.

The second web panel 24b is folded with respect the second inner corner panel 22b and with respect to the second outer corner panel 26b. This folding may be automatic in response to folding the first end panel 12 with respect to the base panel 14.

The first outer corner panel 26a is folded, with respect to the first side panel 18 about fold line 27a, as indicated by direction arrow D2 shown in FIG. 2.

The first web panel 24a is folded between the first outer corner panel 26a and the first inner corner panel 22a.

A portion of the first outer corner panel 26a is brought into face contacting relationship with a portion of the first inner corner panel 22a. In this way the first outer corner panel 26a is secured to the first inner corner panel 22a.

The second outer corner panel 26b is folded, with respect to the second side panel 20 about fold line 27b, as indicated by direction arrow D3 shown in FIG. 2.

The second web panel 24b is folded between the second outer corner panel 26b and the second inner corner panel 22b.

A portion of the second outer corner panel 26b is brought into face contacting relationship with a portion of the second inner corner panel 22b. In this way the second outer corner panel 26b is secured to the second inner corner panel 22b.

Glue or other adhesive treatment is applied to the inner surface of each of the third and fourth outer corner panels 26c, 26d.

The second end panel 16 is folded, with respect to the base panel 14 about fold line 15, as indicated by direction arrow D4 shown in FIG. 2.

The second end panel 16 is brought into face to face relationship with the base panel 14.

The third inner corner panel 22c is brought into face to face relationship with the first side panel 18. The fourth inner corner panel 22d is brought into face to face relationship with the second side panel 20.

In alternative embodiments glue or other adhesive treatment may applied to the outer surface of each of the third and fourth inner corner panels 22c, 22d. The glue or other adhesive treatment may be applied after folding the third and fourth inner corner panels 22c, 22d into face to face relationship with the respective one of the first and second side panels 18, 20.

The third web panel 24c is folded with respect the third inner corner panel 22c and with respect to the third outer corner panel 26c. This folding may be automatic in response to folding the second end panel 16 with respect to the base panel 14.

The fourth web panel 24d is folded with respect the fourth inner corner panel 22d and with respect to the fourth outer corner panel 26d. This folding may be automatic in response to folding the second end panel 16 with respect to the base panel 14.

The third outer corner panel 26c is folded, with respect to the first side panel 18 about fold line 27c, as indicated by direction arrow D5 shown in FIG. 2.

The third web panel 24c is folded between the third outer corner panel 26c and the third inner corner panel 22c.

A portion of the third outer corner panel 26c is brought into face contacting relationship with a portion of the third inner corner panel 22c. In this way the third outer corner panel 26c is secured to the third inner corner panel 22c.

The fourth outer corner panel 26d is folded, with respect to the second side panel 20 about fold line 27d, as indicated by direction arrow D6 shown in FIG. 2.

The fourth web panel 24d is folded between the fourth outer corner panel 26d and the fourth inner corner panel 22d.

The position of the fourth inner corner panel 22d and the fourth web panel 24d below the fourth outer corner panel 26d is indicated by phantom lines (dot-dash) in FIG. 2, it will be appreciated that the other corner structures are similarly arranged.

A portion of the fourth outer corner panel 26d is brought into face contacting relationship with a portion of the fourth inner corner panel 22d. In this way the fourth outer corner panel 26d is secured to the fourth inner corner panel 22d.

It will be appreciated that assembly of the third and fourth corner structures may be carried out substantially simultaneously with assembly of the first and second corner structures.

In this way a single gluing process can be applied to each corner structure so as to form the blank into a flat-collapsed, part assembled tray-carrier 90. It is not necessary to secure the web panels 24a, 24b, 24c, 24d to each of the first and second corner panels 22a, 22b, 22c, 22d, 26a, 26b, 26c, 26d.

The flat collapsed tubular structure is formed as shown in FIG. 2. The flat collapsed carrier can be readily shipped or distributed in the flat condition to a plant for erecting and loading with primary product containers; or directly to a point of sale where a server may erect the flat collapsed carrier into a tray, for example, being loaded with a food item, such as a hot-dog and immediately served to a customer.

The flat collapsed carrier can be opened into a tray-style article carrier by unfolding the first and second end panel 12, 16 with respect to base panel 14. The first and second side panels 18, 20 may be automatically erected into side walls by virtue of their connection to the first and second end panels 12, 16 through the respective one of the corner structures 22a/24a/26a, 22b/24b/26b, 22c/24c/26c, 22d/24d/26d.

In some embodiments the flat collapsed carrier can be opened into a tray-style article carrier by folding the first and second side panels 18, 20 with respect to the base panel 14, the end walls 12, 16 and corner structures 22a/24a/26a, 22b/24b/26b, 22c/24c/26c, 22d/24d/26d may be automatically erected in response.

The erected carrier is shown in FIG. 3. The corner structures 22a/24a/26a, 22b/24b/26b, 22c/24c/26c, 22d/24d/26d provide leak resistant corners of the tray, thus sealing the tray and forming an at least substantially leak-proof tray. The first and second end panels 12, 16 form end walls of the tray, the end walls may be disposed at an oblique orientation with respect to the base panel 14.

The first and second side panels 18, 20 form side walls that may be disposed at an oblique orientation with respect to the base panel 14.

It will be appreciated that the first, second, third and fourth angles θ1, θ2, θ3, θ4 may be adjusted to alter the angle of inclination of the end walls 12, 16 with respect to the base panel. The first and second end panels 12, 16 may be arranged to be inclined at an acute, obtuse or perpendicular angle with respect to the base panel 14.

The corner structures 22a/24a/26a, 22b/24b/26b, 22c/24c/26c, 22d/24d/26d prevent or inhibit the first and second side panels 18, 20 and the first and second end panels 12, 16 from unfolding into a coplanar relationship with the base panel 14, that is to say from reverting to the unfolded blank condition shown in FIG. 1.

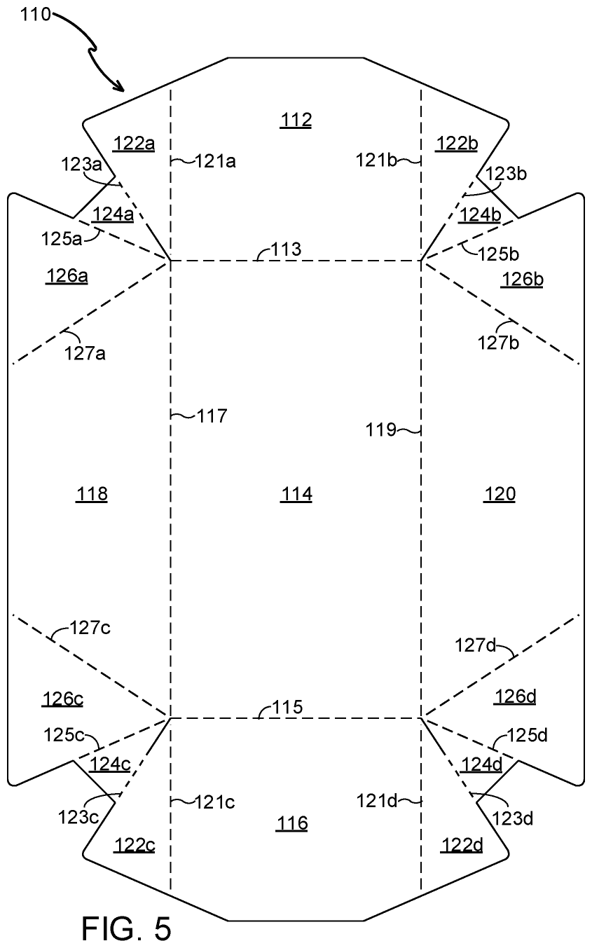

Referring now to FIG. 5, there is shown an additional embodiment of the present invention. In the second illustrated embodiments like numerals have, where possible, been used to denote like parts, albeit with the addition of the prefix “100” to indicate that these features belong to the second embodiment. The additional embodiment shares many common features with the first embodiment, and therefore only the differences from the embodiment illustrated in FIGS. 1 to 4 will be described in any greater detail.

In FIG. 5 a second embodiment is illustrated; a blank 110 comprises a base panel 114, opposed end panels 112, 116 and opposed side panels 118, 120. A first end panel 112 is hingedly connected to a first end of the base panel 114 by a hinged connection in the form of a fold line 113. A second end panel 114 is hingedly connected to a second end of the base panel 114 by a hinged connection in the form of a fold line 115. A first side panel 118 is hingedly connected to a first side of the base panel 114 by a hinged connection in the form of a fold line 117. A second side panel 120 is hingedly connected to a second side of the base panel 114 by a hinged connection in the form of a fold line 119.

The blank 110 comprises a corner structure 122a/124a/126a, 122b/124b/126b, 122c/124c/126c, 122d/124d/126d at each corner of the base panel 114. The corner structures 122a/124a/126a, 122b/124b/126b, 122c/124c/126c, 122d/124d/126d couple one of the opposed end panels 112, 116 to one of the opposed side panels 118, 120.

The fold lines 117, 119 are linear in shape. The first, second, third and fourth outer corner panels 126a, 126b, 126c, 126d are arranged to have substantially equal height to the first and second side panels 118, 120 when in an erected condition.

The frangible line 30 of the first embodiment has been omitted.

The blank 110 is formable into a carrier (not shown) by a series of sequential folding operations in a straight-line machine so that the carrier is not required to be rotated or inverted to complete its construction. The folding process may be similar to that described above in relation to the embodiment of FIGS. 1 to 4, and is not described further.

The folding process is not limited to that described below and may be altered according to particular manufacturing requirements. For example the corner structures may be folded such that the inner corner panels 22a, 22b, 22c, 22d; 122a, 122b, 122c, 122d are disposed outermost and the outer corner panels 26a, 26b, 26c, 26d; 126a, 126b, 126c, 126d are disposed innermost, the web panels 24a, 24b, 24c, 24d; 124a, 124b, 124c, 124d being disposed in between the respective pair of inner and outer corner panels 22a, 22b, 22c, 22d, 26a, 26b, 26c, 26d; 122a, 122b, 122c, 122d, 126a, 126b, 126c, 126d.

It can be appreciated that various changes may be made within the scope of the present invention. For example, the size and shape of the panels and apertures may be adjusted to accommodate articles of differing size or shape. In one alternative embodiment the plurality of teeth may be replaced with a continuous wall which surrounds the applicator article group, the lower edge of the wall may be castellated or crenellated with one or more recesses to accommodate the peripheral walls of the tray component.

It will be recognised that as used herein, directional references such as “top”, “bottom”, “base”, “front”, “back”, “end”, “side”, “inner”, “outer”, “upper” and “lower” do not necessarily limit the respective panels to such orientation, but may merely serve to distinguish these panels from one another.

As used herein, the terms “hinged connection” and “fold line” refer to all manner of lines that define hinge features of the blank, facilitate folding portions of the blank with respect to one another, or otherwise indicate optimal panel folding locations for the blank. Any reference to “hinged connection” should not be construed as necessarily referring to a single fold line only; indeed a hinged connection can be formed from two or more fold lines wherein each of the two or more fold lines may be either straight/linear or curved/curvilinear in shape. When linear fold lines form a hinged connection, they may be disposed parallel with each other or be slightly angled with respect to each other. When curvilinear fold lines form a hinged connection, they may intersect each other to define a shaped panel within the area surrounded by the curvilinear fold lines. A typical example of such a hinged connection may comprise a pair of arched or arcuate fold lines intersecting at two points such that they define an elliptical panel therebetween. A hinged connection may be formed from one or more linear fold lines and one or more curvilinear fold lines. A typical example of such a hinged connection may comprise a combination of a linear fold line and an arched or arcuate fold line which intersect at two points such that they define a half moon-shaped panel therebetween.

As used herein, the term “fold line” may refer to one of the following: a scored line, an embossed line, a debossed line, a line of perforations, a line of short slits, a line of half-cuts, a single half-cut, an interrupted cutline, a line of aligned slits, a line of scores and any combination of the aforesaid options.

It should be understood that hinged connections and fold lines can each include elements that are formed in the substrate of the blank including perforations, a line of perforations, a line of short slits, a line of half-cuts, a single half-cut, a cutline, an interrupted cutline, slits, scores, any combination thereof, and the like. The elements can be dimensioned and arranged to provide the desired functionality. For example, a line of perforations can be dimensioned or designed with degrees of weakness to define a fold line and/or a severance line. The line of perforations can be designed to facilitate folding and resist breaking, to facilitate folding and facilitate breaking with more effort, or to facilitate breaking with little effort.

The phrase “in registry with” as used herein refers to the alignment of two or more elements in an erected carrier, such as an aperture formed in a first of two overlapping panels and a second aperture formed in a second of two overlapping panels. Those elements in registry with each other may be aligned with each other in the direction of the thickness of the overlapping panels. For example, when an aperture in a first panel is “in registry with” a second aperture in a second panel that is placed in an overlapping arrangement with the first panel, an edge of the aperture may extend along at least a portion of an edge of the second aperture and may be aligned, in the direction of the thickness of the first and second panels, with the second aperture.

1. An article carrier for a foodstuff comprising a base wall, opposed side walls hingedly connected to opposed sides of the base wall and opposed end walls hingedly connected to opposed ends of the base wall, wherein each of the end walls is coupled to each of the side walls by a corner structure, each corner structure comprising: a first corner panel; a second corner panel; and a web panel, the web panel being hingedly connected to each of the first and second corner panels and being disposed between said first and second corner panels in face contacting relationship therewith, and the web panel comprising a cutaway located distally from the base wall, such that the first corner panel is directly securable to the second corner panel.

2. An article carrier according to claim 1, wherein a frangible line extends continuously across the base wall and opposed side walls such that the article carrier is divisible into two sections.

3. An article carrier according to claim 1, wherein each of the opposed side walls is hingedly connected to the base wall by a non-linear fold line.

4. An article carrier according to claim 3, wherein each non-linear fold line comprises a pair of linear portions divergently arranged with respect to each other.

5. An article carrier according to claim 4, wherein a frangible line extends continuously across the base wall and opposed side walls such that the article carrier is divisible into two sections, and wherein the frangible line intersects each of the non-linear fold lines at a vertex, which vertex is defined by an intersection between the pair of linear portions of non-linear fold line.

6. An article carrier according to claim 1, wherein the article carrier is collapsible into a flat condition.

7. An article carrier according to claim 1, wherein the article carrier is erectable from a flat condition in which the end walls are disposed in face to face relationship to the base wall.

8. An article carrier according to claim 7, wherein the side walls and corner structures are automatically erected in response to unfolding the end walls with respect to the base wall.

9. An article carrier according to claim 7, wherein the end walls and corner structures are automatically erected in response to folding the side walls with respect to the base wall.

10. An article carrier according to claim 1, wherein one of the first and second corner panels forms an outer corner panel and extends from a respective one of the opposed side walls to a respective one of the opposed end walls.

11. An article carrier according to claim 1, wherein one of the first and second corner panels forms an outer corner panel and extends from a respective one of the opposed side walls to a respective one of the opposed end walls.

12. An article carrier according to claim 1, wherein one of the first and second corner panels forms an outer corner panel and when viewed from an external viewpoint substantially conceals from view the other one of the first and second corner panels and the web panel.

13. A blank for forming an article carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel interconnecting the first and second corner panels and being hingedly connected to each of the first and second corner panels by first and second hinged connections, wherein the web panel is foldable about the first and second hinged connections so as to be disposed between first and second corner panels in face contacting relationship therewith, and wherein the web panel comprises a cutaway located distally from the base wall, such that the first corner panel is securable to the second corner panel.

14. An article carrier for forming a tray for a foodstuff comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels and being disposed between first and second corner panels in face contacting relationship therewith, and wherein the web panel is shorter in height than the first and second corner panels, such that the first corner panel is securable to the second corner panel.

15. A blank for forming an article carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels by first and second hinged connections, wherein the web panel is foldable about the first and second hinged connections so as to be disposed between first and second corner panels in face contacting relationship therewith, and wherein the web panel is shorter in height than the first and second corner panels, such that the first corner panel is securable to the second corner panel.

16. An article carrier for a foodstuff comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels and being disposed between first and second corner panels in face contacting relationship therewith, and wherein each of the first and second corner panels each comprise a projection providing a securing region such that the first corner panel is securable to the second corner panel.

17. A blank for forming an article carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels by first and second hinged connections, wherein the web panel is foldable about the first and second hinged connections so as to be disposed between first and second corner panels in face contacting relationship therewith, and wherein each of the first and second corner panels each comprise a projection providing a securing region such that the first corner panel is securable to the second corner panel.

18. An article carrier for a foodstuff comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels and being disposed between first and second corner panels in face contacting relationship therewith, and wherein each of the first and second corner panels each comprise a projection providing a securing region, said securing regions being adjacent to each other.

19. A blank for forming an article carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels by first and second hinged connections, wherein the web panel is foldable about the first and second hinged connections so as to be disposed between first and second corner panels in face contacting relationship therewith, and wherein each of the first and second corner panels each comprise a projection providing a securing region, said securing regions being adjacent to each other in an assembled condition.

20. An article carrier for a foodstuff comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels and being disposed between first and second corner panels in face contacting relationship therewith, and wherein each of the first and second corner panels each extend radially outward from a corner of the base wall further than the web panel such that the first corner panel is securable to the second corner panel.

21. A blank for forming an article carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising a first corner panel, a second corner panel and a web panel hingedly connected to each of the first and second corner panels by first and second hinged connections, wherein the web panel is foldable about the first and second hinged connections so as to be disposed between first and second corner panels in face contacting relationship therewith, and wherein each of the first and second corner panels each extend radially outward from a corner of the base wall further than the web panel such that the first corner panel is securable to the second corner panel.

22. A method of assembling a carrier of the tray type, the carrier comprising a base wall, opposed side walls hingedly connected to opposed sides of the base wall and opposed end walls hingedly connected to opposed ends of the base wall, wherein each of the end walls is coupled to each of the side walls by a corner structure, the corner structure comprising an inner corner panel, an outer corner panel and a web panel hingedly connected to each of the first and second corner panels by first and second hinged connections, the method comprising;
folding each of the opposed end walls about hinged connections to the base wall into face contacting relationship with the base wall;
bringing each of the inner corner panels into face contacting relationship with a respective one of the opposed side walls;
applying glue or other adhesive treatment to an inner surface of each outer corner panel;
folding each of the outer corner panels about their hinged connections to one of the opposed side walls;
interposing each web panel between respective ones of the inner and outer corner panels;
bringing each of the outer corner panels into face contacting relationship with a respective one of the inner corner panels; and
securing each of the outer corner panels to said respective one of the inner corner panels.

23. A method according to claim 22, further comprising:
erecting the carrier into a tray;
folding each side wall about a hinged connection to the base wall; and
unfolding each end wall about a hinged connection to the base wall.

24. A method according to claim 22, further comprising:
erecting the carrier into a tray;
folding each side wall about a hinged connection to the base wall wherein each of the end walls unfolds about a hinged connection to the base wall in response to folding the opposed side walls.

25. A method according to claim 22, further comprising:
erecting the carrier into a tray;
unfolding each end wall about a hinged connection to the base wall wherein each of the side walls folds about a hinged connection to the base wall in response to unfolding the opposed end walls.

26. A method according to claim 22, wherein glue or other adhesive treatment is applied to an inner surface of each outer corner panel prior to folding each of the opposed end walls about hinged connections to the base wall into face contacting relationship with the base wall.

27. Use of the method of claim 22 in a straight line gluing machine to form a carrier as claimed in claim 1.
